(19) United States
(12) Patent Application Publication
(10) Pub. No.: US 2025/0382946 A1
(43) Pub. Date: Dec. 18, 2025

(54) Wind-resistant energy harvesting tower

(71) Applicant: VERTICAL GREEN ENERGY LTD., Herzlia (IL)

(72) Inventor: Aviv Carmel, Herzlia (IL)

(21) Appl. No.: 19/264,922

(22) Filed: Jul. 10, 2025

Related U.S. Application Data
(63) Continuation-in-part of application No. 18/688,452, filed on Mar. 1, 2024, now Pat. No. 12,395,114.
(60) Provisional application No. 63/239,978, filed on Sep. 2, 2021.

(51) Int. Cl. F03D 9/00; H02S 20/30

(52) U.S. Cl. CPC F03D 9/007; H02S 20/30; F05B 2220/708; F05B 2270/20; F05B 2270/32

(57) ABSTRACT

Wind-resistant energy harvesting tower including a main column extending vertically from a base, and a plurality of ledges extending laterally outward from main column, each ledge including solar panel for absorbing and converting solar energy into electricity. Tower includes wind turbine positioned between ledges, for converting wind energy into alternate energy. At least one of main column and ledges is rotatable to orient tower to minimize drag when subject to wind loads. A rotor may rotate ledges to a ledge orientation for increasing wind resistance of tower. Main column may include wind resistance geometry to enable rotation of main column about its longitudinal axis when subject to wind loads. Ledges may include first ledge portion having lower wind resistance and second ledge portion having higher wind resistance and longer than first ledge portion, for compelling a rotation of ledge along wind direction when subject to a wind load.

### CROSS-REFERENCE TO RELATED APPLICATIONS

This application is a Continuation-in-Part of U.S. patent application Ser. No. 18/688,452, filed on Mar. 1, 2024, which is a National Stage Entry of PCT International Application No. PCT/IL2022/050959, filed on Sep. 1, 2022, which claims the benefit of U.S. Provisional Patent Application 63/239,978, filed on Sep. 2, 2021. The foregoing applications are incorporated herein by reference in their entirety.

### TECHNICAL FIELD

The present disclosure generally relates to energy harvesting from renewable resources, and particularly to structures for harvesting wind and solar energy.

### BACKGROUND

Humanity's ever-growing energy consumption, which energy is still mainly derived from non-renewable energy sources such as fossil fuels and the like, has become a major worldwide issue. This issue involves two aspects. Firstly, there is the risk of running out of energy resources due to overuse of non-renewable resources. The second and more urgent aspect is the danger of increased pollution of the environment as a result of the non-renewable energy consumption, which can result in contaminated air, global warming, extinction of plant and animal species, and general destruction of the ecological balance. Intensive research is ongoing after novel energy sources, and development of technologies which allow high-efficiency harnessing of the prevalent renewable energy sources. Two of the most central renewable energy sources are solar energy and wind energy.

### SUMMARY

In accordance with one aspect of the present disclosure, there is thus provided an energy harvesting system for mounting on a towering construction, for harvesting energy from renewable resources. The energy harvesting system includes an array of wind turbines dispersed along the towering construction and configured to rotate when exposed to a wind load for converting wind kinetic energy into a different form of energy, and a plurality of laterally outlying ledges branching outwardly in vertically spaced-apart respective levels, alternately lined-up along the towering construction above one of, below one of, or between two of, the wind turbines. Each of the ledges includes at least one of an upper ledge surface, which is slanted at a slope for deflecting ingoing wind upwardly toward an immediately adjacent-above wind turbine, and/or for diffusing outgoing wind downwardly away from an immediately adjacent-above wind turbine; and a lower ledge surface, which is slanted at a slope for deflecting ingoing wind downwardly toward an immediately adjacent-below wind turbine, and/or for diffusing outgoing wind upwardly away from an immediately adjacent-below wind turbine, such that each of the wind turbines is disposed below an immediately adjacent-above lower ledge surface and/or above an immediately adjacent-below upper ledge surface. Each of the ledges also includes a photovoltaic (PV) solar panel layout disposed at least on the upper ledge surface, the solar panel layout including at least one PV solar panel for absorbing and converting solar energy into electricity.

According to an aspect of the present disclosure, the system further includes a gravitational energy storage module, configured to conserve the energy of the electricity produced by the wind turbines and the PV solar panels, by elevating a weighted load, configured to be lifted along the towering construction, to an elevated position, by the produced electricity, and allowing the weighted load to drop from the elevated position to a lower position for releasing kinetic energy, where the weighted load includes an electrical/spring energy storing artifact, operational to store further electrical/spring energy produced by the wind turbines and the PV solar panels. The electrical/spring energy storing artifact may include electric batteries, electric capacitors, or compressible springs.

The gravitational energy storage module may further include: a water tank, disposed at the elevated position; water tubes, extending along the towering construction; and a water pump, powered by the produced electricity and operational for elevating water through the water tubes to the water tank.

The water tubes may extend adjacently to the PV panels such that the water flowing within the water tubes is operational for at least one of: conveying a cooling effect to the PV panels, and conveying a cleansing effect to the PV panels, for increasing effectivity of the PV panels. The water tubes may be in fluid communication with a water supply system, allowing streaming the water into the water supply system at or above a predetermined pressure level. The energy harvesting system may include a sun-heated boiler disposed on the towering construction, wherein the water tubes are in fluid communication with the sun-heated boiler, allowing the water to be heated before being streamed into the water supply system.

According to a further aspect of the present disclosure, an upper portion of the towering construction is configured to be horizontally rotatable about a vertical axis running therethrough, for adjusting the horizontal orientation of the wind turbines and of the PV solar panel layout, which are disposed on the towering construction, for increasing exposure of the wind turbines to the wind load and/or exposure of the PV panels to the solar energy.

At least one of the upper ledge surface and the lower ledge surface may be slanted at a fixed angular elevation relative to the horizon. The fixed angular elevation of the upper ledge surface may be in the range of 1°−45° relative to the horizon, or more specifically in the range of 27°-33° relative to the horizon. The angular elevation relative to the horizon of at least one of the upper ledge surface and the lower ledge surface may be dynamically adjustable.

The plurality of laterally outlying ledges may span a portion of the circumference of the towering construction, the portion including at least one azimuth range of 90°-270° relative to the true north, and 270°-90° relative to the true north. The PV solar panel may be tiltable with respect to a north-south axis, allowing adjusting the angle of the surface of the PV solar panel relative to the true north, for increasing absorption of solar energy by the PV solar panel. The angular elevation of the PV solar panel with respect to the horizon may be adjustable, for increasing absorption of solar energy by the PV solar panel. The energy harvesting system may include a controller configured to tilt the PV solar panel according to a predetermined program.

The energy harvesting system may further include at least one wind sensor, configured to measure the wind load at least at one portion of the circumference of the towering construction; at least one solar sensor, configured to measure the intensity of the solar energy at least at one portion of the circumference of the towering construction; and a controller, wherein the controller is configured to receive data from the wind sensor and the solar sensor; to analyze the data so as to define an optimal directionality of the towering construction with respect to the true north in which the energy harvesting system harvests energy at a maximal efficiency; and to provide a signal indicating the optimal directionality.

The towering construction may be configured to be tilted at a non-vertical slant, allowing increasing the exposure of the solar panel to solar energy. The towering construction may include a steel tower-crane-like structure.

In some embodiments, at least one of the wind turbines may include a vertical axis. In some embodiments, at least one of the wind turbines may include a horizontal axis.

In accordance with another aspect of the present disclosure, there is thus provided a wind-resistant energy harvesting tower, including a main column extending vertically from a base. The tower includes a plurality of ledges extending laterally outward from the main column, each ledge comprising at least one solar panel for absorbing and converting solar energy into electricity. The tower includes at least one wind turbine, positioned between the ledges, for converting wind energy into an alternate form of energy. At least one of the main column and the ledges is rotatable to orient the tower to minimize drag when subject to wind loads.

According to aspects of the present disclosure, the wind-resistant energy harvesting tower may include one or more of the following features. At least one rotor may be configured to rotate at least one of the ledges about a lateral rotation axis orthogonal to the main column, to a ledge orientation for increasing wind resistance of the tower. At least one of the main column and the ledges may include a wind resistance geometry, configured to enhance a wind resistance of the tower. The main column may include a wind resistance geometry configured to enable a rotation of the main column about its longitudinal axis when subject to wind loads. The main column may include a teardrop-shaped cross-sectional profile. A rotation restraint may be configured to selectively restrain rotation of the main column. The rotation restraint may be configured to be deactivated when a wind speed exceeds a predetermined threshold. A rotation facilitator may be configured to selectively facilitate rotation of the main column. At least one of the ledges may include a first ledge portion having a lower wind resistance and a second ledge portion having a higher wind resistance, the second ledge portion being longer than the first ledge portion, for compelling a rotation of the ledge along the wind direction when subject to a wind load. Each ledge may include multiple ledge segments, each ledge segment including a first ledge surface and a second ledge surface that adjoin at an angle. At least one of the main column and the ledges may include a wind resistant cladding. At least one sensor may be configured to measure environmental conditions. An orientation of at least one of the main column and the ledges may be adjusted based on measurements from the sensor. A rotating of at least one of the main column and the ledges may be responsive to detected wind conditions meeting predetermined wind resistance criteria.

According to another aspect of the present disclosure, a method of operating a wind-resistant energy harvesting tower is provided. The method includes arranging a plurality of ledges extending laterally outward from the main column extending vertically from a base of the tower, each ledge including at least one solar panel for absorbing and converting solar energy into electricity, the tower including at least one wind turbine between the ledges for converting wind energy into an alternate form of energy. The method includes rotating at least one of the main column and the ledges, to orient the tower to minimize drag when subject to wind loads.

According to other aspects of the present disclosure, the method may include one or more of the following features. The method may include rotating at least one of the ledges about a lateral rotation axis orthogonal to the main column using at least one rotor; and selecting a ledge orientation of the ledges to increase wind resistance of the tower. The main column may include a wind resistance geometry, and the method may further include enabling rotation of the main column about its longitudinal axis when subject to wind loads based on the wind resistance geometry. Each ledge may include a first ledge portion having a lower wind resistance and a second ledge portion having a higher wind resistance, the second ledge portion being longer than the first ledge portion, and the method may further include compelling rotation of the ledge along the wind direction when subject to a wind load based on the different wind resistances of the first and second ledge portions. The method may further include detecting wind conditions at the tower, determining if the detected wind conditions meet predetermined wind resistance criteria, and if the wind resistance criteria are met, rotating at least one of the main column and the ledges to a selected orientation to increase wind resistance of the tower. The method may further include, if the wind resistance criteria are not met, rotating at least one of the main column and the ledges to an orientation that optimizes energy harvesting from at least one of sunlight and wind.

### BRIEF DESCRIPTION OF THE DRAWINGS

The present disclosure will be understood and appreciated more fully from the following detailed description taken in conjunction with the drawings in which:

FIG. 1 is an illustration of an energy harvesting system, constructed and operative according to an embodiment of the present disclosure;

FIG. 2A is a cross-sectional illustration of the energy harvesting system of FIG. 1;

FIG. 2B is a top-view illustration of the energy harvesting system of FIG. 1;

FIG. 3A is an illustration of an energy harvesting system including wind and solar sensors and a rotatable towering construction, constructed and operative according to an embodiment of the present disclosure;

FIG. 3B is an illustration of a horizontal-axis wind turbine positioned between two ledges of the embodiments of FIG. 1 or 3A;

FIG. 3C is an illustration of a towering construction which is tilted to slant at a first non-vertical angle, constructed and operative according to another embodiment of the present disclosure;

FIG. 3D is an illustration of the towering construction of FIG. 3C, which is tilted to slant at a second larger non-vertical angle;

FIG. 3E is an illustration of an upper ledge surface of the energy harvesting system of FIG. 3A, including tiltable PV solar panels;

FIG. 4 is an illustration of an energy harvesting system including a plurality of water tubes and connected to a water system, constructed and operative according to an embodiment of the present disclosure;

FIG. 5 is an illustration of an energy harvesting system including an elevatable weighted load, constructed and operative according an embodiment of to the present disclosure;

FIG. 6A is a cross-sectional illustration of a portion of an energy harvesting system of any one of the preceding Figures, including two ledges enclosing a wind turbine;

FIG. 6B is a cross-sectional illustration of the portion of an energy harvesting system of FIG. 6A, where the wind is coming from the opposite direction;

FIG. 7 is an illustration of an energy harvesting system where the towering construction is an existing building, constructed and operative according an embodiment of to the present disclosure;

FIGS. 8A and 8B illustrate perspective views of a first exemplary wind resistant tower for an energy harvesting system, according to aspects of the present disclosure;

FIGS. 8C and 8D illustrate side orthographic views of a first exemplary wind resistant tower for an energy harvesting system, according to aspects of the present disclosure;

FIGS. 8E and 8F illustrate front orthographic views of a first exemplary wind resistant tower for an energy harvesting system, according to aspects of the present disclosure;

FIGS. 8G and 8H illustrate top orthographic views of a first exemplary wind resistant tower for an energy harvesting system, according to aspects of the present disclosure;

FIG. 9A illustrates a perspective view of a second exemplary wind resistant tower for an energy harvesting system, according to aspects of the present disclosure;

FIG. 9B illustrates a cross-section of a main column geometry of a second exemplary wind resistant tower, according to aspects of the present disclosure;

FIG. 9C illustrates a side orthographic view of a second exemplary wind resistant tower, according to aspects of the present disclosure; and

FIG. 9D illustrates a top orthographic view of a second exemplary wind resistant tower, according to aspects of the present disclosure.

### DETAILED DESCRIPTION OF THE EMBODIMENTS

The present disclosure overcomes the disadvantages of the prior art by providing an energy harvesting system, for harvesting energy from renewable resources. The system includes an array of wind turbines disposed along a towering construction and configured to rotate when exposed to a wind load, for converting the wind kinetic energy into a different form of energy, and a plurality of laterally outlying ledges branching outwardly in vertically spaced-apart respective levels, alternately lined-up along the towering construction between the wind turbines. Each of the ledges includes an upper ledge surface and a lower ledge surface, which ledge surfaces extend outwards from their respective positions on the towering construction at opposing vertical slants, such that distal ends of the respective upper ledge surface and lower ledge surface are adjacent or connected. The upper and lower ledge surfaces are slanted at a slope for deflecting ingoing wind upwardly and downwardly, respectively, toward an immediately adjacent wind turbine, and/or diffusing outgoing wind downwardly and upwardly, respectively, away from the adjacent wind turbine. A photovoltaic (PV) solar panel layout is disposed at least on the upper ledge surface, and includes at least one PV solar panel for absorbing and converting solar energy into electricity. The laterally outlying ledges usually span at least half of the circumference of the energy harvesting system. The system may include one or more energy storage modules, usually operational for being lifted along the towering construction, for accumulating and storing energy for later use. The towering construction may also include wind and solar sensors and may be rotatable, so as to adjust the horizontal orientation of the towering construction according to the prevalent wind load and solar intensity for optimal energy harvesting.

Reference is now made to the Figures, in which like numbers designate like parts.

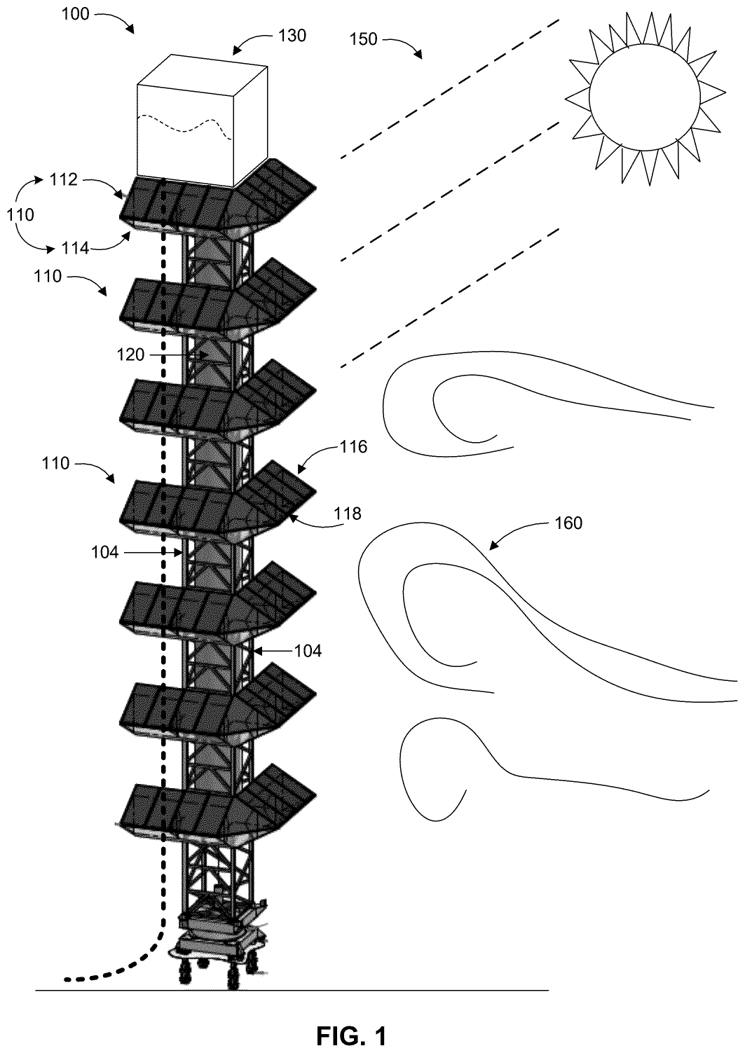

FIG. 1 is an illustration of an energy harvesting system, designated 100, constructed and operative according to the present disclosure. System 100 is installed upon a towering construction 102, and includes an array of wind turbines 120 dispersed along towering construction 102 and interspersed with a plurality of laterally outlying ledges 110. Each of ledges 110 includes an upper ledge surface 112 and a lower ledge surface 114. Ledge surfaces 112, 114 extend peripherally from the positions on the towering construction walls 104 to which they are each respectively coupled. Upper ledge surface 112 extends at a downward slope and lower ledge surface 114 extends at an upward slope, such that ledge surfaces 112 and 114 meet at their distal ends. Upper ledge surface 112 includes a photovoltaic (PV) solar panel layout 116, made up of an array of solar panels 118 which substantially overlay upper ledge surface 112. Water tank 130 is installed at an upper region of towering construction 102, and is in fluid communication with water tubes 132, which extend from the bottom to the top of towering construction 102.

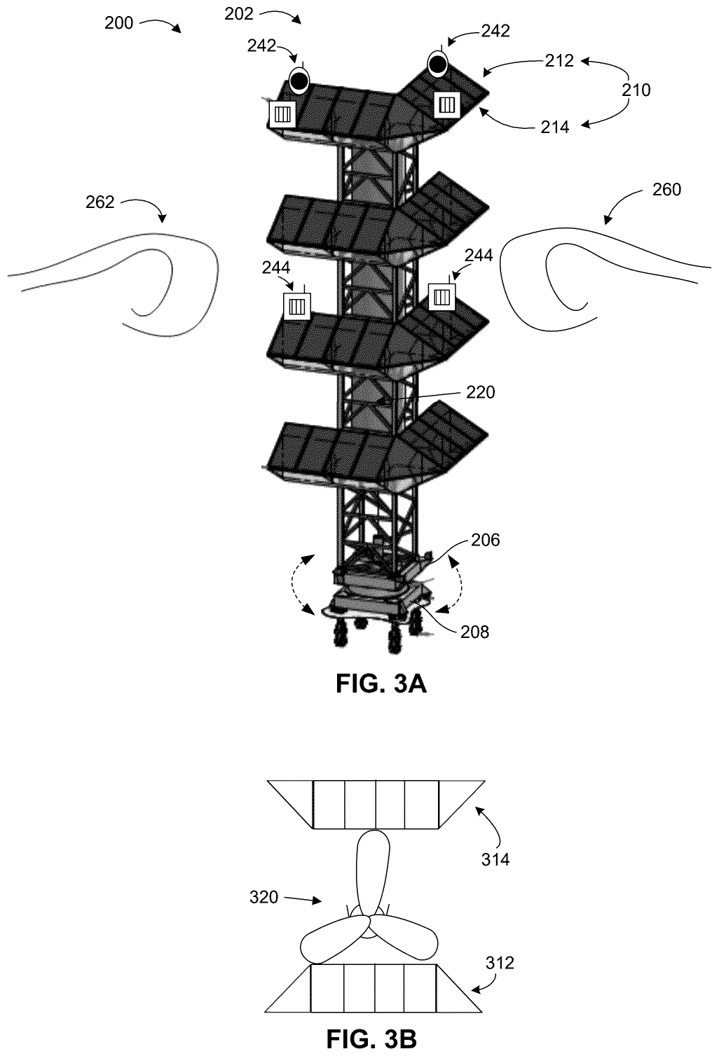

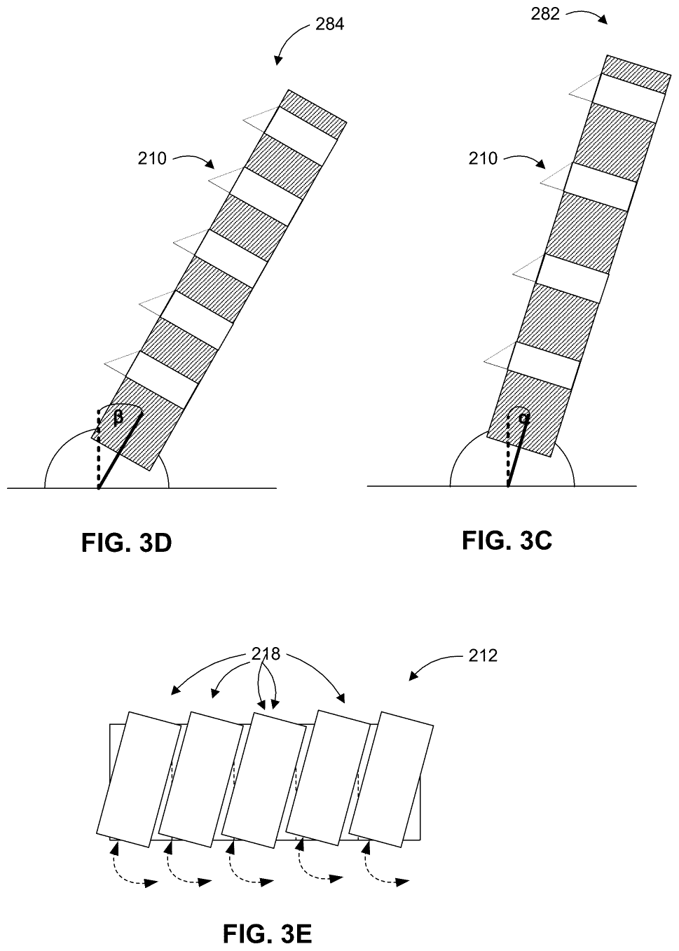

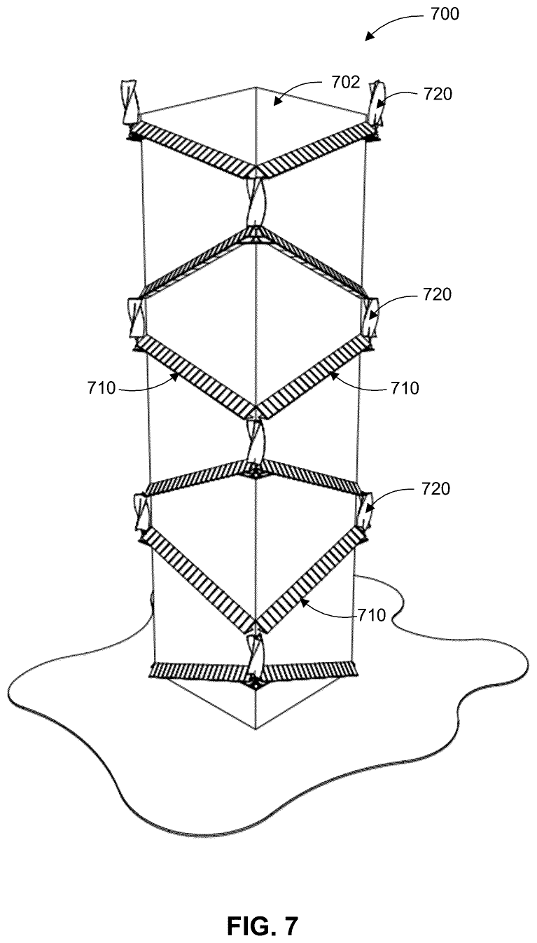

Towering construction 102 includes a tower-crane-like vertical structure, e.g., featuring a lattice of beams, usually made of steel but possibly including any other strong, durable and easy to construct material, e.g., aluminum, plastic, etc. The steel crane-like structure has several substantial advantages, including sturdiness, durability and stability even when extending to considerable heights (e.g., 40-50 meters), easy and low-cost production and erection, low wind drag profile, and in particular a low ground surface-area footprint. This structure is also well suited to being rotated about a vertical axis running there-through or being tilted to a non-vertical slant, which possibilities are explained hereinbelow with reference to FIGS. 3A-3D. The crane-like structure also allows easy modularity, i.e., to easily extend or reduce the height of towering construction 102 according to need, respectively increasing or reducing the number of ledges 110 installed there-upon. However, the towering construction can include any other vertically extending structure, either erected especially to serve as an energy harvesting system or for any other purpose, including a skyscraper, a multi-story building, a pole, a lamp post, a tower-crane, a tree trunk, and the like. When the towering construction has hollow spaces or compartments along its length, particularly (but not limited to) when the hollows are substantially open to wind flow from at least two opposing all directions, the wind turbines may be disposed within these hollows. When the towering construction contains no such hollows, the wind turbines, as well as the ledges, may also be disposed on the circumference of the towering construction. An add-on embodiment exemplifying addition of the system to an existing polygonal building (e.g., featuring a full rectangular cap) is shown in FIG. 7.

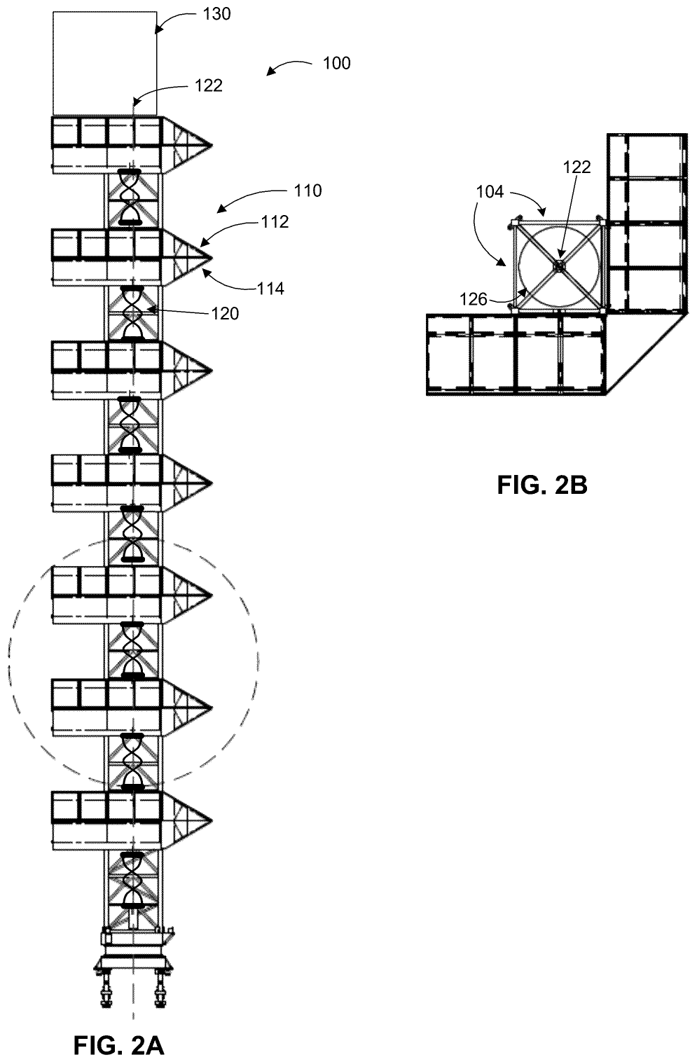

Reference is also made to FIG. 2A, which is a cross-sectional illustration of energy harvesting system 100, and to FIG. 2B which is an above-view of energy harvesting system 100 (water tank 130 is excluded for clarity). Wind turbines 120 are vertical-axis wind turbines, which are aligned along the length of towering construction 102 such that they share a substantially common vertical axis 122. Vertical axis 122 runs through the center of towering construction 102, i.e., through the center of the virtual horizontal circle 126 which is enclosed by walls 104 of towering construction 102. Each of turbines 120 is positioned between two laterally outlying ledges 110, one ledge 110 above turbine 120 and one below. When wind turbines 120 are aligned with the central vertical axis 122 of towering construction 102, the vertical axis of wind turbines 120 together with their even and balanced structure renders turbines 120 equally responsive to wind loads originating from any direction. Alternatively, wind turbines 120 may not share a common vertical axis, and each turbine 120 may be located at an independent location relative to vertical axis 122. Conversely, wind turbines 120 may indeed share a common vertical axis, which does not run through the center of towering construction 102. More than one wind turbine 120 may be disposed at each “floor” (level) of towering construction 102, i.e., between two neighboring adjacent ledges 110, and turbines 120 may be arranged in parallel vertical arrays or distributed in any other formation. The towering construction itself may not be vertically uniform, e.g., may have a zigzag or a slanting vertical formation, and each wind turbine 120 may be disposed at a central position of its respective floor, which is not vertically aligned with the central position of neighboring floors. Wind turbines 120 may be positioned adjacently to walls or at corners of a towering construction, and respective ledges may be installed above and below the turbines (120) which slantingly extend along the walls of the towering construction (e.g., the embodiment of FIG. 7).

Ledges 110 which hem in turbines 120 at least to some extent, increase the wind speed and/or the wind pressure at turbines 120, elevating the quantity of (kinetic) energy harvested by turbines 120, as will be further explained herein. Each of ledges 110 spans substantially half of the circumference of towering construction 102. Ledges 110 are usually disposed so as to cover an azimuth range which matches the trajectory of the sun during daytime, i.e., 90°-270° relative to the true (geodetic) north, or 270°-90° relative to the true north, depending on which side of the equator towering construction 102 is erected. PV solar panel layout 116 covers upper ledge surface 112, such that at least one of PV panels 118 is exposed to direct sunlight during all daylight hours of a 24 hour day. Alternatively, ledges 110 may span a smaller section of the circumference of towering construction 102, e.g., 135°-225; a larger section of the circumference of towering construction 102, e.g., the entire circumference; or may be intermittently dispersed around the circumference of towering construction 102, with gaps between portions of ledge 110. Upper ledge surface 112 of ledges 110 may be entirely covered by PV solar panel layout 116, and may even be essentially made up of PV solar panels 118. Also sections of ledge 110 which point in a direction which is never exposed to direct sunlight may be covered by PV solar panels 118, so as to absorb reflected or ambient solar energy. Although PV solar panels are most efficient at converting direct sunlight into electricity, they are also effective at absorbing and converting reflected/ambient solar energy. Therefore, lower ledge surface 114 may also be coated with PV solar panels 118, so as to increase the yield of energy harvesting system 100. Alternatively, PV solar panel layout 116 may cover only a portion of ledge 110, usually the portion which points in the direction of prevalent direct sunlight, whereas other areas of ledge 110 may remain uncovered by PV panels, serving (only) the purpose of increasing the wind speed and/or the wind pressure at turbines 120. The angular elevation relative to the horizon, at which upper ledge surface 112 and/or lower ledge surface 114 are slanted, may be fixed, possibly according to an angle which is, on average, most conducive both to wind deflecting and channeling and to solar energy absorption. For example, the angular elevation of upper ledge surface 112 may be in the range of 1°-45° relative to the horizon, or more specifically in the range of 27°-33° relative to the horizon, or within another range selected according to latitude and/or season. Alternatively, the angular elevation relative to the horizon of ledge surfaces 112 and 114 may be dynamically adjustable, as will be further explained with respect to the positioning and orientation of the PV solar panels (FIG. 3E).

Towering construction 102 may include a plurality of ledges 110, disposed at different heights there-along, which may each span different portions of the circumference of towering construction 102, and/or may each include a different number of PV solar panels 118. The vertical distance between each pair of neighboring ledges 110 may be uniform along towering construction 102, or may vary. One of the considerations in the vertical spacing apart of ledges 110 may be to minimize the shade that each ledge 110 casts on the PV solar panels 118 residing upon a neighboring ledge 110 located below it. The further spaced apart ledges 110 are from each other, the less they will block their neighboring ledges 110 from direct sunlight. However, the further spaced apart ledges 110 are along towering construction 102 the less ledges 110 will fit thereon, which may reduce the number of PV panels 118 which are in the capacity of towering construction 102 to support and, by extension, reduce its solar energy harvesting capacity. The preponderance of direct sunlight in a particular geographical region, as well as the difference between the electricity yield of PV panels 118 when exposed to direct sunlight, to their yield when exposed to indirect or reflected sunlight, are factors which should be taken into account with regard to the spacing apart of ledges 110. This is with regard only to solar energy calculations, but there are of course also wind energy considerations. The vertical height of each wind turbine 120 corresponds to the vertical distance between the two ledges 110 which encompass it, i.e., is of a height which fits within, and optionally fills, the gap between the two ledges 110, such that a larger gap between two neighboring ledges 110 allows inserting at least one larger and more productive wind turbine there-between. On the other hand, as mentioned, larger gaps between ledges 110 necessarily decreases the number of ledges 110, and correspondingly the number of PV panels 118 which can be installed on towering construction 102. Therefore, in addition to the solar energy considerations that were mentioned previously in the context of spacing ledges 110, the prevailing wind conditions in the particular vicinity of towering construction 102 should also be accounted for.

Even within a particular towering construction 102, the spacing of ledges 110 there-along, and the characteristics of each ledge 110 with respect to the portion of the circumference of towering construction 102 which it spans and with regard to its coating with PV panels 118, may be planned according to the differences in wind speed and wind direction, and sunlight absorption, at different heights along towering construction 102. For example, the lower section of a towering construction, e.g., the bottom 16 meters from the ground, may include ledges 110 installed every 4 meters, with a relatively small wind turbine 120 disposed in between, and with PV panels 118 only on the upper ledge surface 112 of each of the ledges 110. The section of the towering construction 102 above 16 meters from the ground may include ledges installed every 6 meters, with a larger wind turbine installed there-between, and with PV panels 118 covering also the lower ledge surface 114. This distinction between the lower and upper sections of towering construction 102 is planned in accordance with higher wind loads and more reflected sunlight being prevalent at the higher sections of towering construction 102, which make larger wind turbines, and additional PV solar panels which harvest indirect sunlight, more profitable at these sections. The wind and sunlight conditions may be widely diverse in different settings, however, and energy harvesting system 100 may be adapted to suit the climate conditions and construction settings in which it is destined to be erected, so as to include an optimal combination of wind turbines, ledges, and solar panels installed there-upon.

Another method of adapting to the prevalent wind and solar conditions for increased energy harvesting efficiency, may be adjusting the directionality of the elements of the energy harvesting system, e.g., the PV solar panels and/or the towering construction. Reference is now made to FIG. 3A which shows an energy harvesting system 200 including a rotatable towering construction 202 and adjustable PV solar panels 218. Towering construction 202 includes revolving base 206 at a bottom region of towering construction 202, and at least one solar intensity sensor 242 and at least one wind intensity sensor 244 which are coupled with controller 240. Revolving base 206 carries an upper portion of towering construction 202, including ledges 210 and wind turbines 220, and is coupled with fixed base 208, such that revolving base 206 is configured to revolve about a vertical axis running through the center of revolving base 206, with respect to fixed base 208 which remains stationary. When revolving base 206 revolves it adjusts the azimuth directionality of ledges 210 and wind turbines 220 with respect to the true (geodetic) north. Solar intensity sensor 242 and wind intensity sensor 244 are configured to measure the solar intensity and wind intensity, respectively, at least at a section of the circumference of towering construction 202. A plurality of sensors 242 and 244 may be positioned at different positions around the circumference of towering construction 202, and at different heights there-along. The data measured by sensors 242 and 244 is received by controller 240, which is configured to: analyze the received data; compute the potential quantity of wind and solar energy, combined, which may be harvested when towering construction 202 points in different directions; assess a substantially optimal directionality of towering construction 202 with respect to the true north in which the energy harvesting system harvests energy at a maximal efficiency; and to turn revolving base 206 so as to point towering construction 202 in the assessed optimal direction, or to provide a signal indicating the optimal direction for towering construction 202. Sensors 242 and 244 may be operational to continuously measure the solar and wind intensity, and controller 240 may be operational to continuously make assessments based on the provided data. Alternatively, controller 240 may make assessments intermittently, for example, every day, every month, every change of season, and the like. Revolving base 206 may be at the bottom of towering construction 202, such that almost the entire length of towering construction 202 is rotated when revolving base 206 revolves, or may be at any position along the height of towering construction 202 (provided there is at least one ledge 210 and one wind turbine 220 there-above), such that towering construction 202 includes a bottom portion, including ledges 210, PV solar panels 218, and wind turbines 220, which remains in a fixed directionality, and an upper portion which is rotated by revolving base 206 according to the assessments of controller 240. With reference to FIG. 3B, it is noted that at least one of the wind turbines may be a horizontal-axis turbine 320, instead of vertical-axis turbines, or may have any other axis operational for wind energy harvesting. The rotation of towering construction 202 to face an optimal directionality is more significant in the context of horizontal-axis wind turbines 320, as they are efficient at wind-energy harvesting only when the blades of turbine 320 are facing the incoming wind, in contrast to vertical-axis turbines which are substantially omni-directional.

In addition to rotating about an axis, towering construction 202 may also be operational to slant at an off-vertical angle, either dynamically on a hinge, according to sensed wind and solar conditions, or statically, i.e., in a fixed construction. With reference to FIG. 3C, towering construction 282 is slanted at a first off-vertical angle α, and has an increased number of ledges 210 per meter relative to towering construction 202. With further reference to FIG. 3D, towering construction 284 is slanted at a second increased off-vertical angle β (where β>α), and has an increased number of ledges 210 per meter relative to towering construction 282. In some embodiments the slant may be static, where construction 282, 284 is fixedly slanted at a particular angle and in other embodiments construction 282, 284 is dynamically slanted at a changeable angle by a slanting mechanism. If the vertical distance between ledges 210 and the dimensions of solar panels 218 are maintained as in towering construction 202, the off-vertical slant of towering constructions 282, 284 may simply reduce the over-shadowing which each of ledges 210 casts on a respective neighboring ledge 210 installed there-below, at least during some hours of the day. Reducing the over-shadowing increases the absorption of direct solar energy and the production of electricity by solar panels 218, which are layed out on the neighboring ledge 210. Additionally or alternatively, the density of ledges 210 (including solar panel layout 216) per meter along the height of towering construction 282, 284, and/or the length of the solar panels, may be increased, correspondingly increasing the energy yield of the energy harvesting system. The angular elevation relative to the horizon of solar panels 218 may also be adjustable, as is further explained with reference to the following FIG. 3E), so as to be optimally coordinated with the off-vertical slant of towering constructions 282, 284. The optional off-vertical slant of the towering construction may have additional advantages, such as allowing the towering construction to blend more easily in different environments, both visually and practically.

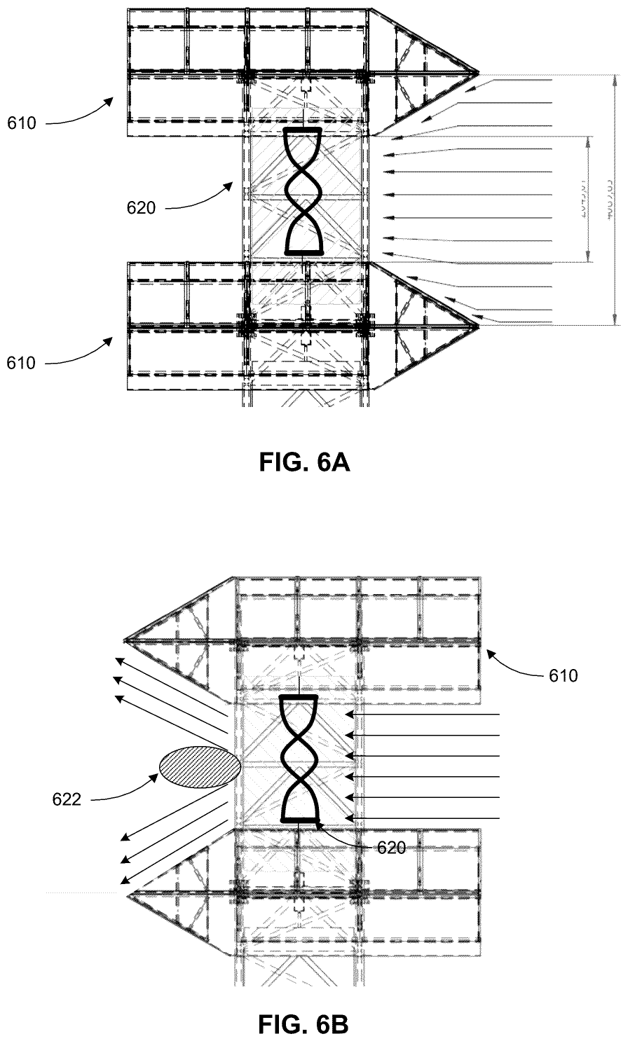

Reference is now made to FIG. 3E which is an enlarged illustration of ledge 210, including PV panels 218 which are tilted or rotated away from their “paving stone orientation”, i.e., the orientation when PV panels 218 lay side by side forming a continuous coating of upper ledge surface 212, so as to better absorb direct sunlight. As the trajectory of the sun in the sky during the course of a day is fixed, the tilting of PV panels 218 may be predefined and repeated on a daily basis so as to substantially track direct sunlight. Alternatively, PV panels 218 may be set at default to remain stationary in their paving stone orientation, and may be tilted only under particular conditions, e.g., when an indication is received from controller 240. The optional rotation of PV panels 218 may be another parameter which controller 240 uses to assess the optimal direction of towering construction 202. For example, if the intensity of winds 260, 262 is highest at an azimuth of 90° but solar intensity is highest at 135° azimuth, and solar intensity is currently substantially more energy proficient, controller 240 may indicate the preferred rotation of revolving base 206 and the respective portion of towering construction 202 so that PV panels 218 will point in the direction of 135° azimuth. Alternatively, controller 240 may assess that it is preferable to position towering construction 202 such that ledges 210 will point in the direction of 90° azimuth (or 270°, as will be further explained with reference to FIGS. 6A and 6B) and that only PV panels 218 will be rotated such that their surfaces point substantially in the direction of 135° azimuth.

With respect to direct sunlight tracking, PV panels 218 may be rotatable along a north-south axis, such that the azimuth in which the surface or face of panels 218 is pointing may be adjusted, e.g., to point eastwards (90° relative to the true north) in the morning hours and westwards (270° relative to the true north) in the evening hours. In addition, the angular elevation relative to the horizon of PV panels 218 may also be adjustable, optionally changing to a vertically upright position, a horizontally flat position or to any other angle. These adjustments of the angle of PV panels 218 may be only for the purpose of tracking the sun (for example, the sun is lowest in the sky at sunrise and sunset, and is highest in the sky at noon, so the angular elevation of panels 218 may be changed accordingly), or the adjustments may be also for the purpose of channeling the wind towards or away from turbines 220. In this context, the PV solar panels may change not only their angular orientation, but even their very location on towering construction 202. For example, an array of PV panels may be positioned, during the peak of sunlight hours, such that they are in continuation of upper ledge surface 212, slanting downwardly and distally from towering construction 202, so as to enhance sunlight absorption; and in the night hours they may be folded inward, i.e., to slant downwardly towards towering construction 202, so as to channel wind towards turbines 220. For another example, some of panels 218, which during the daylight hours are positioned on ledge surface 212 so as to absorb direct solar energy, may be repositioned in the night hours so as to form vertical walls. These walls together with lower ledge surface 214 and upper ledge surface 212 basically enclose the wind turbine, at least one from one direction, which may substantially enhance wind intensity and speed at turbine 220. These angular and position adjustments of the PV solar panels may be electrically powered, mechanically powered, e.g., with springs, manually powered, e.g., with a crank, or any combination of the above.

Referring back to FIG. 1, water tank 130 is disposed at an elevated position along towering structure 102, usually near the top thereof, and accumulates water that is raised along water tubes 132 by use of the energy harvested by wind turbines 120 and PV solar panels 118 (of energy harvesting system 100). The harvested energy powers a pump (not shown), which raises the water along towering construction 102, within tubes 132. The pump may be mechanically powered by the rotation of wind turbines 120, and/or may be electrically powered by electricity produced by solar panels 118 and wind turbines 120. Water tubes 132 may be connected to an external water source, such as a well, a river, or a lake, or may lead out of a water tank located at the bottom of towering construction 102 (not shown). Raising water along the height of towering construction 102 may conserve the harvested energy in the form of potential energy, with minimal energy loss. When the potential energy is needed for use, the elevated water may be channeled downward to convert the potential energy into kinetic energy, and possibly into other forms of energy. For example, the water may be streamed through a hydro powered turbine which can convert the kinetic energy of the water into electricity. The elevated water has further advantages and may serve additional purposes.

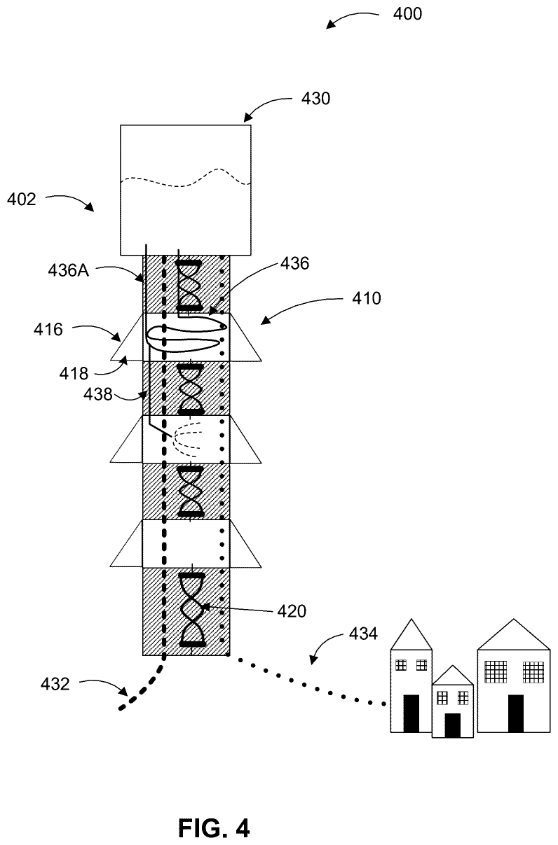

Reference is now also made to FIG. 4, in which energy harvesting system 400 features a variety of water tubes leading in and out of water tank 430. Supply tube 434 channels water which has been elevated and accumulated in water tank 430 to neighboring facilities which require water to be supplied at or above a predetermined pressure, operating in a similar fashion to the operation of a standard water tower. Each additional 10 meters which the water is elevated above the level of the facilities adds an additional 1 atmosphere of pressure to the water in the facilities' water system. For example, if water tank 430 is positioned at the top of towering construction 402, which is at a height of 30 meters above neighboring houses, water from the water tank can be channeled to the neighboring houses at a pressure of 3 atmospheres, which is typically fully sufficient for most household requirements. Some of the water may be held in a sun-heated boiler, which may also be mounted at an elevated position on towering construction 402, so as to also supply hot water to the facilities' water system.

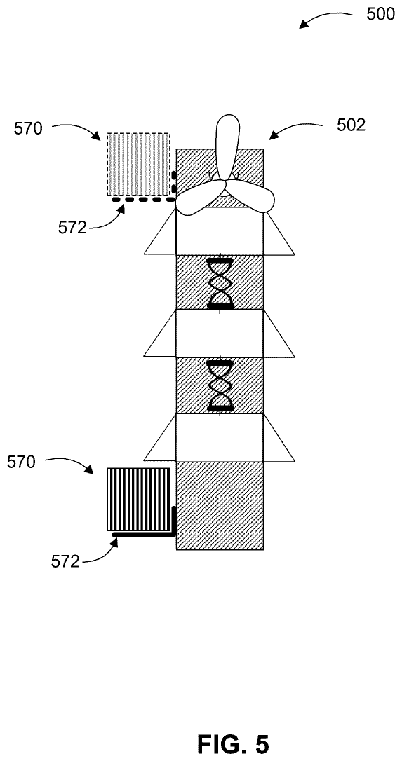

It is noted that also in the context of electricity supply, the energy harvesting system may be on-grid, i.e., connected to a larger or national electricity network, or off-grid, i.e., an independent electricity production and storage system, operational to supply electricity to neighboring facilities. The energy storage modules, e.g., the elevated water tank (130, 430) and the elevated load of FIG. 5, are particularly useful when the energy harvesting system is off-grid.

Another use of the water elevated to the top of towering construction 402 is to cool and/or clean PV solar panels 418 of PV solar panel layout 416. Dirt which accumulates on PV solar panels, and the heating up of the PV solar panels from continuous exposure to direct sunlight, are both factors which may reduce the efficiency of PV panels in converting sunlight into electricity. Cooling tubes 436 extend and wind adjacently to PV panels 418, such that tubes 436 are in contact with the panels 418 and the water within tubes 436 may absorb some of the heat from panels 418, which constantly heat up due to sunlight absorption, for cooling panels 418 and increasing their efficiency. Cooling tubes 436 may be connected in a closed loop to water tank 430, such that water which absorbs heat from panels 418 and heats up, may constantly be removed via tube 436A towards tank 430 and replaced by fresh cool water from tank 430. Alternatively or additionally, water may be streamed through cleansing tube 438, which is an open ended tube that is operationally positioned to stream or spray water on the outer surface of PV panels 418 so as to remove dust and other dirt from PV panels 418. In addition to the cleaning effect, streaming water on panels 418 may also convey a substantial cooling effect thereto.

Reference is now made to FIG. 5, which shows an energy harvesting system 500 including a weighted load 570 elevated along towering construction 502, as another means of energy storage. Energy harvested by wind turbines 520 and PV solar panels 518 powers a lifting mechanism 572 which raises weighted load 570 along towering construction 502. Lifting mechanism 572 may be mechanically powered by the rotation of wind turbines 520, and/or may be electrically powered by electricity produced by solar panels 518 and turbines 520. The elevation of weighted load 570 converts the energy used to elevate load 570 into potential gravitational energy. This potential gravitational energy may be utilized by lowering or dropping load 570 from its elevated position to a lower position, by virtue of gravity, such that the kinetic energy which weighted load 570 acquires during the lowering process is used to drive an electricity producing dynamo or alternator. Weighted load 570 may include simple heavy material (e.g., lead, sand), water (which may also be utilized in conjunction with the water accumulated at the top of the construction), batteries, capacitors, compressible springs (or other compression storage device), or any other energy storing artifact or substance which is operational to store further electricity or energy (e.g., produced by wind turbines 520 and solar panels 518). This energy storing artifact, e.g., a battery (or water), has a dual contribution to the energy and electricity storage of the energy harvesting system: first, as a battery which is charged with electricity which may be utilized when needed (or water which may be utilized as well); and second, as an elevated weight which may be dropped from its elevated position to acquire usable kinetic energy, as explained.

With reference to FIG. 6A, a portion of an energy harvesting system is shown which includes two ledges 610 enclosing a wind turbine 620, where wind enters toward wind turbine 620 from the direction of upper ledge surface 612 and lower ledge surface 614, positioned below and above wind turbine 620 respectively. Ledge surfaces 612 and 614 are angled such that they deflect and channel wind, which is blowing upon ledge surfaces 612, 614 in a substantially horizontal direction, towards wind turbine 620 which is positioned there-between. This increases the wind load at turbine 620, and possibly also the wind speed (similar to the venturi effect), at turbine 620, which in turn increases the speed of rotation and the kinetic energy of wind turbine 620. The equation which describes the relation between an increase in speed and an increase in kinetic energy is: Eₖ=1/2*m*v², such that Eₖ is the kinetic energy, m is the mass of the body which gains speed, and v is the velocity of the body. This equation clearly shows that an increase in speed increases the kinetic energy by the order of a square. Therefore increasing the speed of wind turbine 620 is substantial in the context of energy harvesting. FIG. 6B shows the same portion of an energy harvesting system as in FIG. 6A, when the wind blows toward wind turbine 620 from the opposite direction to ledge surfaces 612 and 614. In this case, ledge surfaces 612 and 614 act as wind diffusers, channeling the wind that passes through turbine 620 so as to spread out away from turbine 620. This causes region 622, which is directly behind turbine 620 relative to the incoming wind, to contain a particularly low air pressure, because the wind is diffused away therefrom by ledge surface 612, 614. This low pressure region 622 causes a vacuum suction effect from behind turbine 620 towards the incoming wind, the vacuum suction accelerates the incoming wind, and the accelerated wind increases the velocity of turbine 620.

According to aspects of the present disclosure, the energy harvesting system may integrate multiple components to generate, store, and utilize renewable energy. The energy harvesting system may combine wind turbines, solar panels, and water management features to maximize energy production and efficiency. Wind turbines positioned along the towering construction may capture kinetic energy from wind currents. The arrangement of ledges extending from the towering construction may help direct and channel wind flow towards the turbines, potentially increasing their efficiency. The ledges may be configured to enhance wind energy capture from multiple directions. Solar panels installed on the upper surfaces of the ledges may convert solar radiation into electrical energy. The positioning and angle of these solar panels may be optimized to maximize sun exposure throughout the day. The solar panels may be adjustable, allowing for tracking of the sun position. The energy harvesting system may incorporate water management features for energy storage and system optimization. An elevated water tank may store water pumped up using energy generated by the wind turbines and solar panels. This stored water may represent potential energy that can be later converted back into electrical energy when needed. The water management system may also serve to enhance the efficiency of other components. Cooling tubes adjacent to the solar panels may help regulate their temperature, potentially improving their performance. A cleansing mechanism may use water to clean the solar panels, maintaining their efficiency by removing dust and debris. The energy harvesting system may include a weighted load mechanism for additional energy storage. Energy produced during periods of high wind or solar availability may be used to elevate a weighted load. When energy demand exceeds immediate production, the potential energy of the elevated load may be converted back into electrical energy by lowering the load. The energy harvesting system may incorporate adaptive features to optimize performance under varying environmental conditions. The towering construction may be rotatable, allowing for adjustment of the energy harvesting system orientation to maximize energy capture based on prevailing wind directions or sun position. The energy harvesting system may operate in different modes depending on environmental conditions. During periods of high wind, the system may prioritize wind energy capture and may adjust its components to enhance stability. In low wind conditions, the system may focus on optimizing solar energy collection. Energy produced by the energy harvesting system may be used immediately or stored for later use. In some cases, the energy harvesting system may be connected to a broader power grid, allowing for energy export during periods of excess production and energy import during periods of high demand. The integration of multiple energy harvesting and storage methods may allow the energy harvesting system to provide a more consistent energy output despite the variable nature of renewable energy sources. This integrated approach may enhance the overall efficiency and reliability of the energy harvesting system.

According to some aspects of the present disclosure, a tower for an energy harvesting system may include at least one wind resistance characteristic for influencing a wind resistance of the tower, such as for minimizing drag and/or reducing surface area exposed to wind, thus enhancing stability of the tower and prevent overturning. In some cases, the tower may include asymmetrical ledges, such as ledges having different portions with different geometries, such that when subject to windy conditions the wind will induce the ledge portions to rotate, reducing the cross-sectional surfaces in direct contact with the wind load. For example, the ledge may include a first ledge portion with a low wind resistance (e.g. low drag coefficient) and relatively short in length, and a second ledge portion with a high wind resistance (e.g. high drag coefficient) and relatively long, causing the ledge to rotate when subject to a high wind load. For example, the ledge may resemble the structure of a “wind vane”, having a “pointer side” and a “tail side” such that the wind directs the pointer side to align with the wind direction. When the windy (e.g., high wind load) conditions end, the tower may revert to an optimal alignment in accordance with the prevailing sunlight and/or wind conditions, such that the orientation of elements of the tower are aligned to optimize energy harvesting from sunlight and/or wind, such as for increasing exposure of the solar panels to solar energy and/or exposure of the wind turbines to wind load. In another example, the ledges may be rotated to a selected orientation for reducing surface area exposed to wind and thereby reducing aerodynamic drag of the tower. The ledges may include a wind resistance geometry for minimizing drag. In a further example, a main column of the tower may be rotatable, such as to align with a wind direction for minimizing drag. The main column may include a wind resistance geometry for inducing rotation when subject to a high wind load. Such a tower with at least one wind resistance characteristic, such as a rotatable ledge and/or a ledge having multiple ledge portions inducing alignment of the ledge with the wind direction, may help ensure that the tower is maintained upright and prevent overturing (irrespective of optimizing energy extraction) under high wind loads and preserve safety. This may also allow for manufacturing a relatively lightweight and low-cost tower, since there is no need to provide additional wind resistance mechanisms, as the tower may be capable of enduring high wind loads up to a reasonable level. The terms “tower” and “towering construction” may be used interchangeably herein.

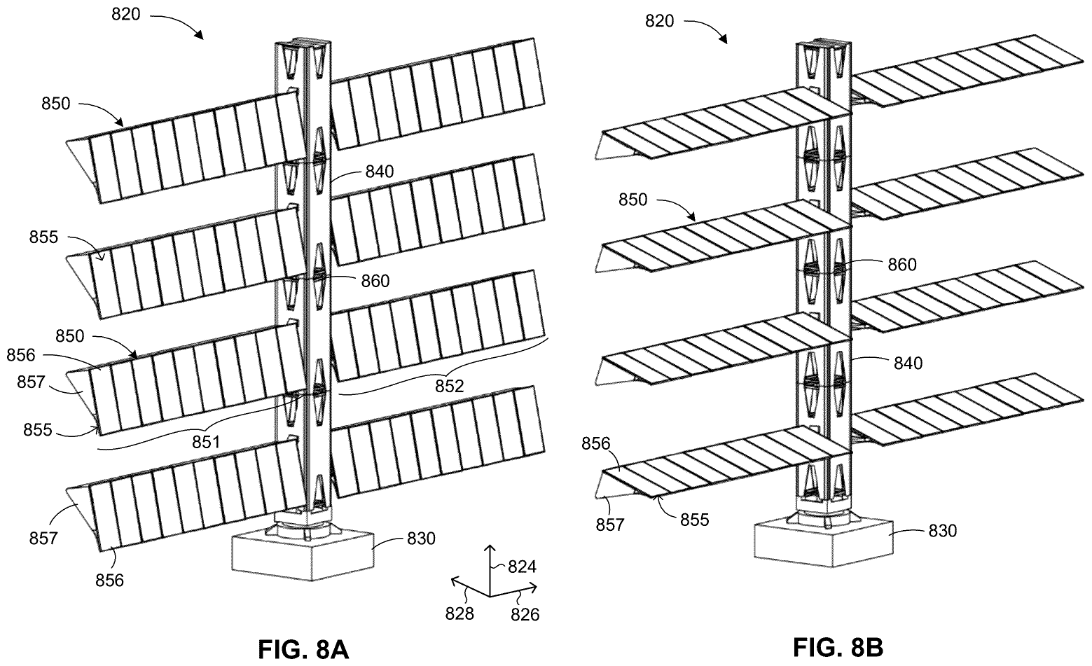

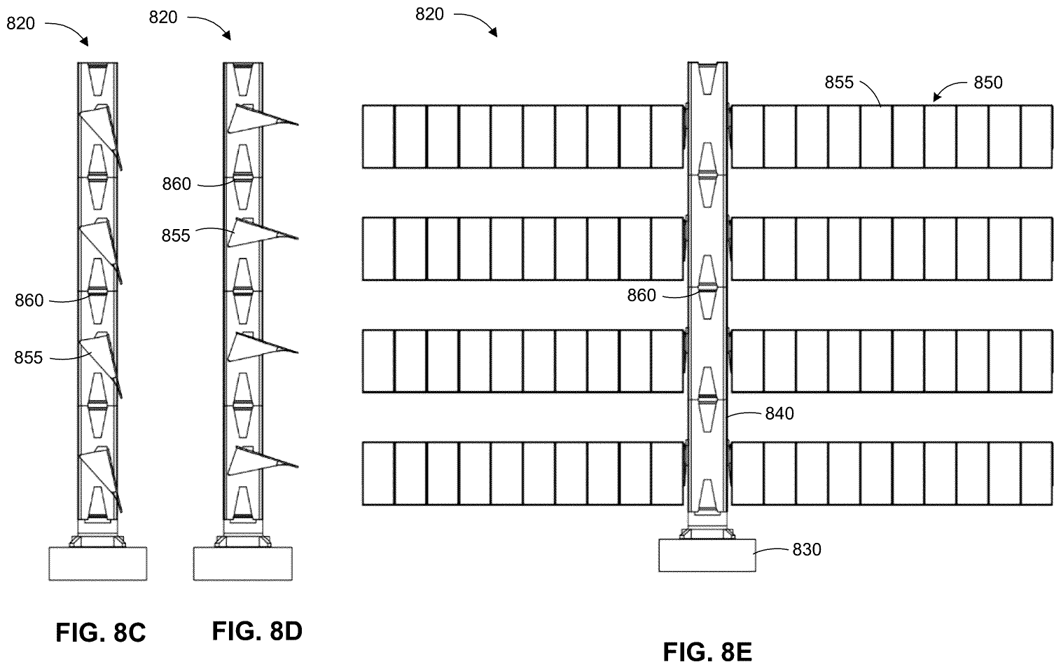

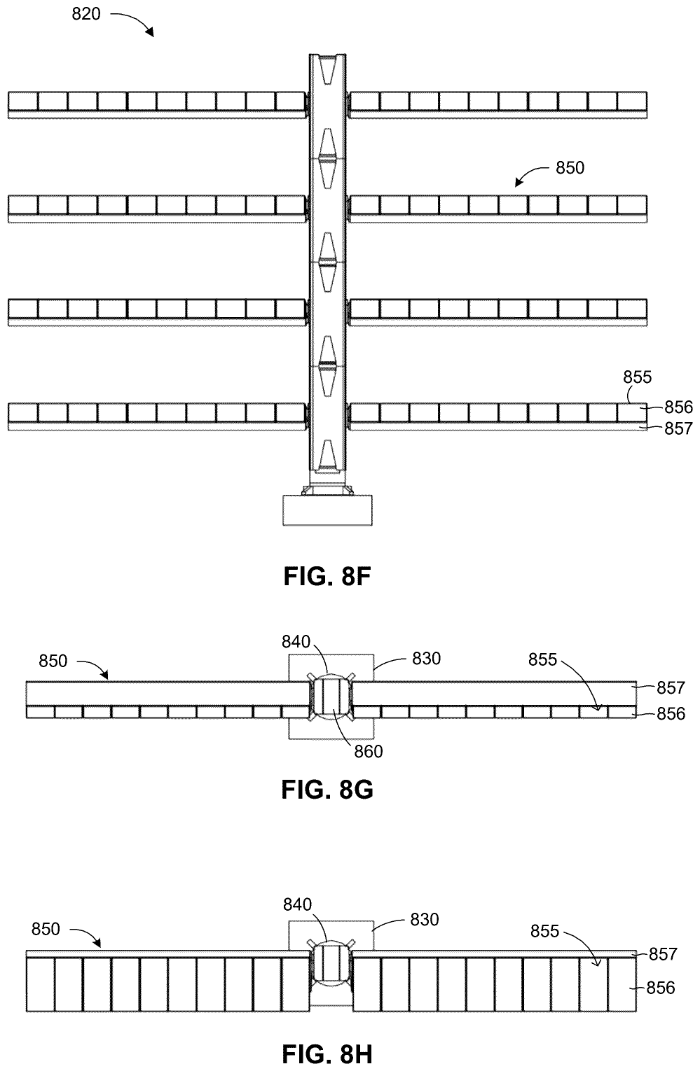

FIGS. 8A-8H schematically illustrate different views of a first exemplary wind resistant energy harvesting tower, generally referenced 820, according to aspects of the present disclosure.

Tower 820 includes a tower base 830 and a main column 840 extending vertically upward from tower base 830. A plurality of ledges 850 project laterally outward from main column 840, such that ledges 850 may be aligned substantially horizontally. Each ledge 850 may include at least one solar panel (not shown), such as a photovoltaic (PV) solar panel, for absorbing and converting solar energy into electricity. Each ledge 850 may include at least one wind turbine (not shown) for absorbing and converting wind energy into electricity.

Ledges 850 may be positioned at regular intervals along the vertical length of main column 850. In some cases, the ledges 850 may be arranged in two groups: a first ledge group 851 positioned on one side of the main column 840, and a second ledge group 852 positioned on an opposing side of the main column 840. Ledges 850 may be arranged substantially symmetrically. For example, ledges 850 may be arranged in rows at different heights along main column 840, with each row including a respective ledge 850 of first ledge group 851 and a respective ledge 850 of second ledge group 852. Each ledge 850 may include multiple ledge segments 855. Each ledge segment 855 may include a first ledge surface 856 and a second ledge surface 857 that adjoin at an angle.

Each ledge 850 may be characterized by a ledge geometry, such as a deflection or bending formed by ledge surfaces 856, 857 of respective ledge portions 855. The ledge geometry of ledges 850 may provide a wind resistance characteristic, such as a drag coefficient. In some examples, tower 820 may be configured to adjust an aerodynamic drag or wind resistance factor, such as to increase or decrease wind resistance, such as by changing an orientation of one or more ledges 850. For example, ledges 850 may be rotatable about a first lateral axis 826 of tower 820, where first lateral axis 826 is orthogonal to a longitudinal axis 824 of main column 840. In some cases, ledges 850 may be further rotatable about a second lateral axis 828 orthogonal to a longitudinal axis 824, and in some cases main column 840 may be rotatable about longitudinal axis 824, to provide up to six degrees of freedom (6DOF) adjustable orientation of ledges 850.

Tower 820 may further include one or more rotors 860 for generating a rotation of at least one ledge 850. A plurality of rotors 860 may be arranged at different heights along main column 840, and may be configured to enable rotation of the ledges 850 relative to main column 840. For example, rotors 860 may be arranged between adjacent ledges 850 within main column 840, and each rotor 860 may be configured to drive a rotation of the ledges 850 positioned at a corresponding height (or row) of main column 840. In some examples, a main rotor 860 may be configured to drive rotation of multiple ledges 850, alternatively individual ledges 850 may be associated with separate rotors 860. Rotors 860 may be configured to rotate ledges 850 about one or more rotational axes, such as first lateral axis 826, second lateral axis 828, and/or longitudinal axis 824 (e.g., pitch, roll, yaw). A controller (not shown) may be provided for controlling operation of rotors 860 for selectively driving rotation of ledges 850 to a selected orientation or inclination (e.g., by controlling the degree and direction of rotation). Rotors 860 may be embodied in various forms and may include suitable electromagnetic or mechanical components for producing and supplying rotational motion.

Ledges 850 may rotate to a selected orientation for optimizing a wind resistance of tower 820 and ensuring that tower 820 is maintained substantially rigid and upright under prevailing wind conditions, regardless of wind direction and wind speed. Tower 820 may be configured to reduce its drag coefficient by adjusting the orientation of one or more ledges 850, such that tower 820 can adjust the surface area exposed to the wind and reduce wind forces subject thereto. A ledge structure of ledges 850, such as a configuration of ledge surfaces 856, 857, may further reduce drag and enhance wind resistance. Tower 820 may further optimize energy harvesting efficiency by selectively directing ledges 850 to an orientation for maximizing exposure to sunlight or wind, such as when not subject to windy conditions.

In some examples, ledges 850 may be brought to an orientation relative to first lateral rotation axis 826, where first ledge surfaces 856 and second ledge surfaces 857 form angled configurations extending outward from main column 840. FIG. 8A illustrates a perspective view of tower 820 with ledges 850 aligned in a first orientation. FIG. 8B illustrates a perspective view of tower 820 with ledges 850 aligned in a second orientation, different from the first orientation (e.g., rotated counterclockwise). FIGS. 8C and 8D illustrate side orthographic views of tower 820 with ledges 850 aligned in the first orientation and second orientation, respectively. FIGS. 8E and 8F illustrate front orthographic views of tower 820 with ledges 850 aligned in the first orientation and second orientation, respectively. FIGS. 8G and 8H illustrate top orthographic views of tower 820 with ledges 850 aligned in the first orientation and second orientation, respectively.

In some cases, tower 820 may operate in a “wind resistance mode”, such as when wind resistance criteria is met, such as when the wind speed is above a predetermined wind speed threshold and/or the wind direction is within a predetermined range. When operating in wind resistance mode, tower 820 may rotate ledges 850 to a selected orientation, such as relative to first lateral rotational axis 826, for increasing a wind resistance of tower 820. The selected orientation may be determined in accordance with real-time wind conditions, which may be obtained using wind measurement sensors (anemometers) or external data sources (e.g., meteorological or climate information sources). Tower 820 may shift to a “default mode” of operation when default criteria is met, such as when the wind speed is below the predetermined wind speed threshold or the wind direction is outside the predetermined range, or after a minimum time period has elapsed following wind resistance mode operation. When operating in default mode, tower 820 may be brought to a position or alignment for optimizing energy harvesting from sunlight and/or wind. For example, ledges 850 may be rotated to maximize sunlight exposure of solar panels on ledges 850, such as by aligning a planar surface of the solar panels substantially perpendicular to the sun direction.

In some cases, ledges 850 may have asymmetric portions that cause ledges 850 to rotate when subject to high wind loads. For example, a ledge 850 may include a first portion with a low wind resistance and relatively short length, and a second portion with a high wind resistance and relatively long length. This asymmetric configuration may cause the ledge 850 to rotate when subject to a high wind load, reducing the cross-sectional surface area in direct contact with the wind load and enhancing stability of the tower 820.

Tower 820 may include a solar panel layout on ledges 850. In some cases, the solar panels in the solar panel layout may be tiltable to track the sun. This tiltable configuration may allow for optimization of solar energy capture throughout the day, independent of the orientation of ledges 850. In some cases, when windy conditions end, the tower 820 may revert to an optimal alignment in accordance with prevailing wind and sunlight conditions. This alignment may optimize energy harvesting from sunlight and wind by adjusting the orientation of the ledges 850 and solar panels.

The wind-resistant design of the tower 820 may allow for a relatively lightweight and low-cost tower structure, as there may be no need for additional wind resistance mechanisms to manage windy conditions. The tower 820 may be configured to endure high wind loads up to a reasonable level through the rotatable ledge system.

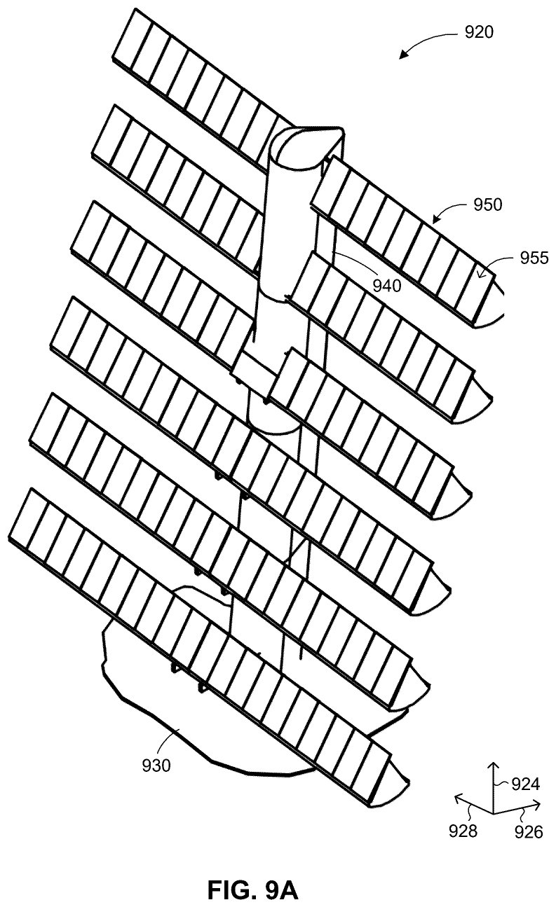

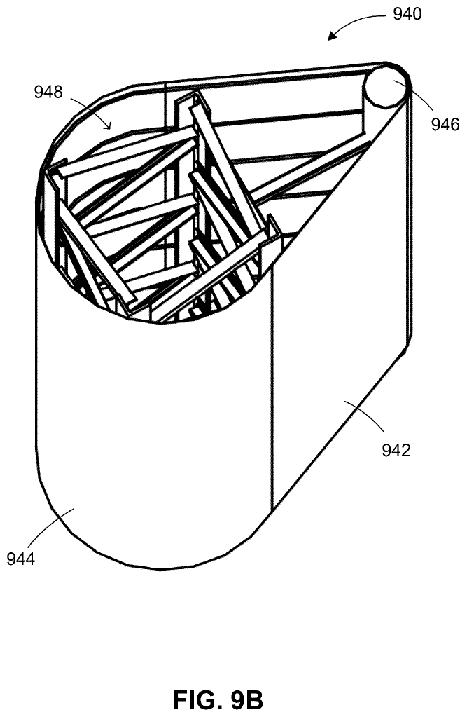

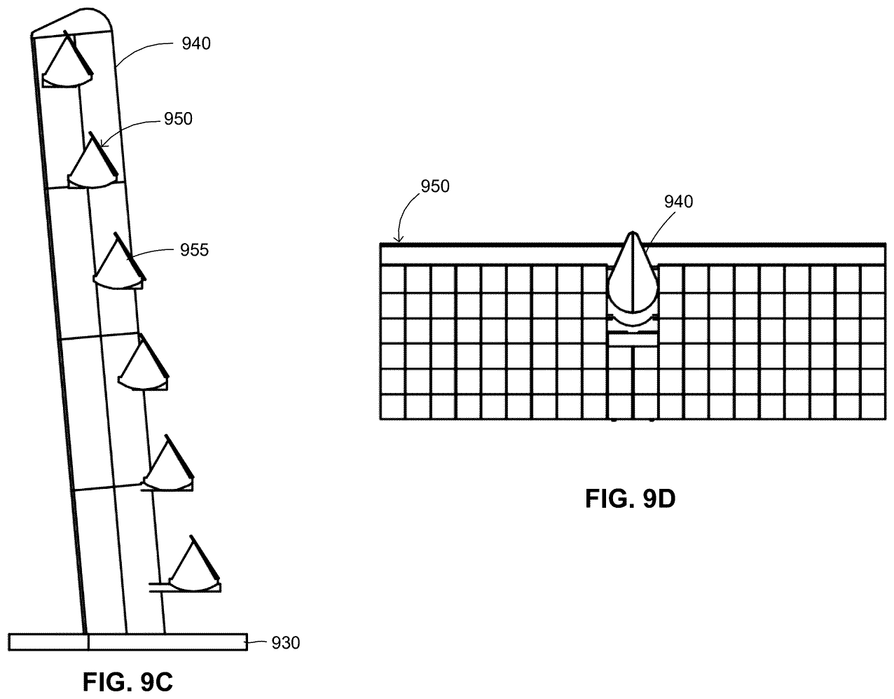

FIGS. 9A-9D schematically illustrate different views of a second exemplary wind resistant energy harvesting tower, generally referenced 920, according to aspects of the present disclosure.

FIG. 9A illustrates a perspective view of tower 920. Tower 920 includes a tower base 930 and a main column 940 extending vertically upwards from tower base 930. A plurality of ledges 950 project laterally outward from main column 940, such that ledges 950 may be aligned substantially horizontally. Each ledge 950 may include at least one solar panel (not shown) for absorbing and converting solar energy into electricity, and each ledge 950 may include at least one wind turbine (not shown) for absorbing and converting wind energy into electricity.

Each ledge 950 may include multiple ledge segments 955 arranged along the length of the ledge 950. Ledges 950 may project outward from opposing sides of main column 940, with ledge segments 955 forming the structure of each ledge 950. Ledges 950 may be arranged in a vertically spaced configuration along main column 940, such as positioned at regular intervals. For example, ledges 950 may be arranged on opposing sides of main column 940, such as with a first group of ledges 950 separated from a second group of ledges 950. Additionally or alternatively, ledges 950 may extend continuously across main column 940. Ledges 950 may be arranged in rows at different heights along main column 940, with each row including one or more ledges 950. Each ledge 950 may have a ledge geometry, which may provide a wind resistance characteristic.

Tower 920 includes several rotational axes. A longitudinal axis 924 extends vertically through main column 940. A first lateral axis 926 extends laterally from main column 940 and orthogonally to longitudinal axis 924. Additionally, a second lateral axis 928 extends laterally from main column 840 and orthogonally to both longitudinal axis 924 and first lateral axis 926. Main column 940 may be rotatable about longitudinal axis 924. Ledges 950 may be rotatable about first lateral axis 926. Ledges 950 may be further rotatable about second lateral axis 928.

Tower 920 may be characterized by a wind resistance geometry, which may provide a wind resistance characteristic. In particular, at least some components of tower 920 may include a geometry or configuration for adjusting an aerodynamic drag or wind resistance factor, such as to increase or decrease the drag, and/or to increase or decrease a surface area of tower 920 exposed to wind. Tower 920 may include one or more additional wind resistance features, in addition to the wind resistance geometry, such as a material composition or coating of one or more components, such as a wind resistant cladding applied to main column 940 and/or ledges 950.

In some examples, the wind resistance geometry of tower 920 may include a cross-sectional profile of main column 940. FIG. 9B illustrates a cross-section of an exemplary main column geometry of tower 920. Main column 940 includes substantially straight surfaces 942 that adjoin an arcuate curved surface 944, forming a teardrop-shaped cross-sectional profile. This teardrop shape may minimize aerodynamic drag on the main column 940. A vertical pillar 946 may be positioned at an intersection of the straight surfaces 942 of the main column 940, extending along longitudinal axis 924. Main column 940 may be configured to rotate about vertical pillar 946. The rotation of main column 940 may occur inherently, responsive to wind conditions, resulting from the geometry of main column 940 (e.g., teardrop-shaped cross-sectional profile). For example, when tower 920 is subject to wind from a particular wind direction, the main column geometry may cause rotation of main column 940 about vertical pillar 946 to orient main column 940 (along with ledges 950 coupled thereto) in an orientation for minimizing drag and reducing the surface area exposed to the wind, thereby ensuring tower 920 is maintained upright.

In some cases, a rotation restraint 948 may be provided within an interior cavity of main column 940 for selectively restraining rotation of main column 940. The wind resistance geometry of main column 940 may allow main column 940 to orient itself in response to wind conditions when the rotation restraint 948 is deactivated. For example, when tower 920 is operating in a wind resistance mode, such as when wind resistance criteria is met, such as when the wind speed is above a predetermined wind speed threshold and/or wind direction is within a predetermined range, rotation restraint 948 may be deactivated and configured to allow free rotation of main column 948 responsive to the wind. When tower 920 is operating in a default mode, such as when default criteria is met, such as when the wind speed is below the predetermined wind speed threshold or the wind direction is outside the predetermined range, rotation restraint 948 may be activated and configured to restrain rotation of main column 940 responsive to the wind. In some examples, ledges 950 may further be configured to rotate, in addition to the rotation of main column 940, such as to a ledge orientation for further minimizing drag and reducing surface area exposed to wind.

In some cases, tower 920 may include a rotation facilitator (not shown), for facilitating rotation of main column 940. For example, tower 920 may include a rotor to produce a rotational force for accelerating the rotation of main column 940, at a faster rate beyond that of the inherent rotation resulting from the wind resistance geometry.

The reflexive rotation of main column 940 responsive to the wind may preclude the need to detect real-time wind conditions via external sensors or data sources, as the alignment of main column 940 to an orientation for minimizing drag may be inherently based on the wind direction. In some cases, tower 920 may not need to shift between different operating modes, such as a wind resistance mode and a default mode, as a wind resistance alignment of tower 920 may occur when necessary, in response to wind conditions, due to the wind resistance geometry of main column 940. For example, when the real-time wind conditions are such that wind resistance is unnecessary, then rotation of main column 940 will not be triggered, and tower 940 may be brought to a position or alignment for optimizing energy harvesting from sunlight and/or wind. For example, main column 940 and ledges 950 may be rotated to maximize sunlight exposure of solar panels, such as bringing the surface of the solar panels to align substantially perpendicular to the sun direction.

Tower 920 may be configured to provide a spontaneous reflexive minimizing of aerodynamic drag and surface area reduction to wind, by a wind resistance geometry of one or more components, such as a geometry of main column 940, and optionally additional wind resistant features, such as a wind resistant cladding of main column 940. This configuration may reduce the drag coefficient regardless of dynamic changes in wind conditions. The wind resistance geometry of main column 940 may resemble that of aircraft stabilizers (i.e., vertical and horizontal stabilizers), such that tower 920 naturally turns according to the wind direction when the rotational restraint 948 is deactivated.

FIG. 9C illustrates a side orthographic view of tower 920. FIG. 9D illustrates a top view orthographic projection of tower 920. In some embodiments, features of the first exemplary wind resistant tower 820 (shown in FIGS. 8A-8H) may be at least partially combined with features of the second exemplary wind resistant tower 920 (shown in FIGS. 9A-9D).

According to some aspects of the present disclosure, the energy harvesting tower may include features to enhance wind resistance characteristics. The tower may incorporate wind resistance geometries to minimize drag and reduce surface area exposed to wind, thereby enhancing stability and preventing overturning during high wind conditions. For example, the main column may have a teardrop-shaped cross-sectional profile, as illustrated in FIG. 9B. This aerodynamic shape may allow the main column to naturally orient itself in response to wind direction when rotation is permitted. In some cases, the ledges may be rotatable about one or more axes. As shown in FIG. 8A and FIG. 8B, the ledges may rotate about a lateral axis orthogonal to the main column. This rotation capability may allow the tower to adjust its wind resistance characteristics based on prevailing wind conditions. The tower may operate in different modes depending on wind conditions. During high wind speeds or when wind direction falls within a predetermined range, the tower may enter a wind resistance mode. In this mode, the ledges may rotate to a selected orientation that optimizes wind resistance and maintains the tower stability. When wind conditions are less severe, the tower may shift to a default mode focused on optimizing energy harvesting. In this mode, the ledges may be oriented to maximize exposure of solar panels to sunlight or to position wind turbines for optimal wind energy capture. In some cases, the main column may be rotatable about its longitudinal axis. As illustrated in FIG. 9A, this rotation may allow the entire tower structure to align with wind direction, further reducing drag and enhancing stability. The tower may include a rotation restraint that can be activated or deactivated based on wind conditions. The ledges may have asymmetric designs that induce self-alignment with wind direction. For example, a ledge may have a shorter portion with lower wind resistance and a longer portion with higher wind resistance. This configuration may cause the ledge to rotate automatically when subjected to high wind loads, reducing the cross-sectional area exposed to wind. The combination of rotatable ledges and a rotatable main column may provide up to six degrees of freedom for adjusting the tower orientation. This flexibility may allow the tower to adapt to a wide range of wind conditions while maintaining stability and optimizing energy harvesting capabilities. In some cases, the tower may include wind and solar sensors to detect environmental conditions. These sensors may provide data to a controller that adjusts the orientation of the ledges and main column accordingly. However, the inherent wind resistance geometries of the tower components may also allow for passive, reflexive adjustments without the need for active sensing and control in some situations. The wind resistance characteristics of the tower may allow for a relatively lightweight and cost-effective structure. By incorporating these features, the tower may be capable of withstanding high wind loads without requiring additional, separate wind resistance mechanisms.

While certain embodiments of the disclosed subject matter have been described, so as to enable one of skill in the art to practice the disclosed subject matter, the preceding description is intended to be exemplary only. It should not be used to limit the scope of the disclosed subject matter, which should be determined by reference to the following claims.

1. A wind-resistant energy harvesting tower, comprising:
a main column extending vertically from a base;
a plurality of ledges extending laterally outward from the main column, each ledge comprising at least one solar panel for absorbing and converting solar energy into electricity; and
at least one wind turbine, positioned between the ledges, for converting wind energy into an alternate form of energy,
wherein at least one of the main column and the ledges is rotatable to orient the tower to minimize drag when subject to wind loads.

2. The wind-resistant energy harvesting tower of claim 1, comprising at least one rotor configured to rotate at least one of the ledges about a lateral rotation axis orthogonal to the main column, to a ledge orientation for increasing wind resistance of the tower.

3. The wind-resistant energy harvesting tower of claim 1, wherein at least one of the main column and the ledges comprises a wind resistance geometry, configured to enhance a wind resistance of the tower.

4. The wind-resistant energy harvesting tower of claim 3, wherein the main column comprises a wind resistance geometry configured to enable a rotation of the main column about its longitudinal axis when subject to wind loads.

5. The wind-resistant energy harvesting tower of claim 4, wherein the main column comprises a teardrop-shaped cross-sectional profile.

6. The wind-resistant energy harvesting tower of claim 4, further comprising a rotation restraint configured to selectively restrain rotation of the main column.

7. The wind-resistant energy harvesting tower of claim 6, wherein the rotation restraint is configured to be deactivated when a wind speed exceeds a predetermined threshold.

8. The wind-resistant energy harvesting tower of claim 4, further comprising a rotation facilitator, configured to selectively facilitate rotation of the main column.

9. The wind-resistant energy harvesting tower of claim 1, wherein at least one of the ledges comprises a first ledge portion having a lower wind resistance and a second ledge portion having a higher wind resistance, the second ledge portion being longer than the first ledge portion, for compelling a rotation of the ledge along the wind direction when subject to a wind load.

10. The wind-resistant energy harvesting tower of claim 1, wherein each ledge comprises multiple ledge segments, each ledge segment including a first ledge surface and a second ledge surface that adjoin at an angle.

11. The wind-resistant energy harvesting tower of claim 1, wherein at least one of the main column and the ledges comprises a wind resistant cladding.

12. The wind-resistant energy harvesting tower of claim 1, further comprising at least one sensor configured to measure environmental conditions.

13. The wind-resistant energy harvesting tower of claim 12, wherein an orientation of at least one of the main column and the ledges is adjusted based on measurements from the sensor.

14. The wind-resistant energy harvesting tower of claim 11, wherein a rotating of at least one of the main column and the ledges is responsive to detected wind conditions meeting predetermined wind resistance criteria.

15. A method of operating a wind-resistant energy harvesting tower, comprising:
arranging a plurality of ledges extending laterally outward from the main column extending vertically from a base of the tower, each ledge comprising at least one solar panel for absorbing and converting solar energy into electricity, the tower comprising at least one wind turbine between the ledges for converting wind energy into an alternate form of energy; and
rotating at least one of the main column and the ledges, to orient the tower to minimize drag when subject to wind loads.

16. The method of claim 15, further comprising: rotating at least one of the ledges about a lateral rotation axis orthogonal to the main column using at least one rotor; and selecting a ledge orientation of the ledges to increase wind resistance of the tower.

17. The method of claim 15, wherein the main column comprises a wind resistance geometry, the method further comprising:
enabling rotation of the main column about its longitudinal axis when subject to wind loads based on the wind resistance geometry.

18. The method of claim 15, wherein each ledge comprises a first ledge portion having a lower wind resistance and a second ledge portion having a higher wind resistance, the second ledge portion being longer than the first ledge portion, the method further comprising:
compelling rotation of the ledge along the wind direction when subject to a wind load based on the different wind resistances of the first and second ledge portions.

19. The method of claim 15, further comprising:
detecting wind conditions at the tower;
determining if the detected wind conditions meet predetermined wind resistance criteria; and
if the wind resistance criteria are met, rotating at least one of the main column and the ledges to a selected orientation to increase wind resistance of the tower.

20. The method of claim 19, further comprising:
if the wind resistance criteria are not met, rotating at least one of the main column and the ledges to an orientation that optimizes energy harvesting from at least one of sunlight and wind.
